(19) United States
(12) Patent Application Publication
(10) Pub. No.: US 2006/0163009 A1
(43) Pub. Date: Jul. 27, 2006

(54) Elevator system having no machineroom

(75) Inventors: Takashi Ishii, Matsudo-Shi (JP); Kan Kawasaki, Mitaka-Shi (JP); Ikuo Asami, Wako-Shi (JP); Satoshi Takasawa, Komae-Shi (JP); Shun Fujimura, Tama-Shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOSHIBA ELEVATOR KABUSHIKI KAISHA, Shinagawa-Ku, Tokyo-To (JP)

(21) Appl. No.: 10/528,815

(22) PCT Filed: Sep. 24, 2003
(86) PCT No.: PCT/JP03/12153

§ 371 Date: Mar. 23, 2005

(30) Foreign Application Priority Data
Sep. 24, 2002 (JP) 2002-277871

(51) Int. Cl. B66B 9/02

(52) U.S. Cl. 187/351; 187/250

(57) ABSTRACT

An elevator system having no machineroom is provided in which a height of a pit in a bottom of an elevator shaft can be reduced, a maintenance operation can be carried out at one on an upper part of the cage, and cage-side sheaves and cage-side guide rails can be disposed symmetrically with respect to the center of gravity of the cage. The elevator system having no machineroom includes a pair of right and left cage-side sheaves 16L and 16R disposed above a cage 10, and a traction sheave 17 disposed behind a cage-side guide rail 11L. The pair of right and left cage-side sheaves 16L and 16R are disposed such that each rotational angle of the pair of right and left cage-side sheaves 16L and 16R is extended parallel to a rotational axis of the traction sheave, or extended at a direction angle close to that of the rotational axis of the traction sheave.

### BACKGROUND OF THE INVENTION

The present invention relates to an elevator system having no machineroom above an elevator shaft.

### DESCRIPTION OF THE RELATED ART

Various elevator systems having no machineroom above an elevator shafts have been developed and proposed for efficiently utilizing a space in a building, and for observing regulations regarding the right to sunlight.

In a conventional elevator system having no machineroom shown in FIGS. 5 and 6, a driving apparatus 3 is securely disposed on a top of a left wall surface 2L of an elevator shaft 2 in which a cage 1 is vertically moved. A hoist rope 5 composed of a plurality of ropes each having a small diameter is wound around a traction sheave 4 driven by the driving apparatus 3.

A part of the hoist rope 5 hanging down from the traction sheave 4 to the cage 1 includes a part 5a which extends downward along a left sidewall 1a of the cage 1, a part 5b which extends horizontally between a pair of right and left cage-side sheaves 1b and 1c mounted under the cage 1 to support the same, and a part 5c which extends upward along a right sidewall 1d of the cage 1 to be secured to a hitch 6 disposed on a top of the elevator shaft. Thus, the cage 1 is suspended in a two-to-one roping arrangement.

The part 5a of the hoist rope 5 which extends downward along the left sidewall 1a of the cage 1 is twisted at a torsion angle of 90 degrees.

Similarly, a part of the hoist rope 5 hanging down from the traction sheave 4 to a counterweight 7 includes a part which extends downward to a counterweight-side sheave 7a rotatably mounted on an upper part of the counterweight 7 to support the same, and a part which extends upward from the counterweight-side sheave 7a to be secured on a not shown hitch disposed on the top of the elevator shaft. This, the counterweight 7 is suspended in a two-to-one roping arrangement.

### OBJECT TO BE SOLVED BY THE INVENTION

In the conventional elevator system having no machineroom shown in FIGS. 5 and 6, since the cage-side sheaves 1b and 1c which support the cage 1 are disposed on a lower part of the cage 1, a space for an operator to check the cage-side sheaves 1b and 1c must be secured in a pit placed in a bottom of the elevator shaft. Thus, a sufficient height of the pit is needed.

In order to extend the hoist rope 5 along the right and left sidewalls 1a and 1d of the cage 1, the pair of right and left cage-side sheaves 1b and 1c must be disposed such that the cage-side sheaves 1b and 1c project from the right and left sidewalls 1a and 1d of the cage 1. Thus, when securing a dimension “W1” of the cage 1 in a right and left direction (opening and closing direction of a door), a dimension “L” of a cross-section of the elevator shaft 2 in a right and left direction must be increased.

In other words, when the dimension “L” of the cross-section of the elevator shaft 2 in a right and left direction is determined at a certain value, the dimension “W1” of the cage 1 in a right and left direction must be reduced.

Maintenances of the driving apparatus 3, the traction sheave 4, and a controller 8 disposed on a top of a sidewall of the elevator shaft 2 must be carried out by an operator who stands on the top of the cage 1 elevated to an uppermost position in the elevator shaft 2.

On the other hand, maintenances of cage-side sheaves 1b and 1c must be carried out by an operator in the pit by lowering the cage 1 to a lowermost position in the elevator shaft 2.

Thus, in the conventional elevator system having no machineroom, a maintenance operation is not efficiently executed, because an operator must go up to an uppermost floor and down to a lowermost floor in the building.

A rotational axis of the traction sheave 4 is extended perpendicular to a left sidewall 2L of the elevator shaft 2. Thus, as viewed vertically from above shown in FIG. 6, the cage-side sheaves 1b and 1c must be disposed in front of the traction sheave 4 (lower part in FIG. 6), and the counterweight-side sheave 7a must be disposed behind the traction sheave 4 (upper part in FIG. 6).

This configuration limits a position where the pair of right and left cage-side sheaves 1b and 1c can be disposed below the cage 1. Thus, when viewed vertically from above, it is difficult for the hoist rope 5 to correspond the part 5b extending horizontally between the pair of right and left cage-side sheaves 1b and 1c to the center of gravity “G” of the cage 1.

### SUMMARY OF THE INVENTION

Therefore, an object of the present invention is to provide an elevator system having no machineroom which solves the above disadvantages of the conventional elevator system. In the elevator system according to the present invention, a height of a pit in a bottom of an elevator shaft can be reduced, and a maintenance operation can be carried out at once on an upper part of a cage. A dimension of a cross-section of an elevator shaft in a right and left direction can be reduced with respect to a width of the cage. In addition, a hoist rope can be passed round the cage such that a part of the hoist rope overlaps the center of gravity of the cage, when viewed vertically from above.

An elevator system having no machineroom according to the present invention comprises: a cage guided by a pair of right and left cage-side guide rails to vertically move in an elevator shaft; a traction sheave disposed behind and near one of the pair of right and left cage-side guide rails, and driven in rotation about a rotational axis extending in a forward and rearward direction; a driving apparatus, disposed behind the traction sheave, for driving the traction sheave in rotation; a counterweight guided by a pair of front and rear counterweight-side guide rails to vertically move in the elevator shaft below the driving apparatus; a pair of right and left cage-side sheaves which suspend the cage and is capable of rotating about a rotational axis extending parallel to a rotational axis of the traction sheave, or extending at a direction angle close to that of the rotational axis of the traction sheave; and a hoist rope composed of a plurality of ropes wound around the traction sheave, having a first part suspending the cage through the pair of right and left cage-side sheaves, and having a second part suspending a counterweight.

The term “forward and rearward direction” is not limited to a direction perpendicular to an opening and closing direction of the door (right and left direction), but includes an angle somewhat inclined to a direction perpendicular to the door opening and closing direction when needed.

In the above elevator system having no machineroom, since the cage-side sheaves are disposed on an upper part of the cage, it is not necessary to secure a space for a maintenance operation in a bottom of the elevator shaft, so that a height of a pit can be reduced.

Further, an operator standing on the upper part of the cage can maintain at once not only the traction sheave and the cage-side sheaves, but also a driving apparatus for driving the traction sheave in rotation and a controlling apparatus for controlling an operation of the driving apparatus. Thus, the operator needs not to go up to the uppermost floor and down to the lowermost floor in the building and an efficient maintenance operation can be carried out.

The hoist rope is not extended along right and left sidewalls of the cage, it is unnecessary for the pair of right and left cage-side sheaves to project from the right and left sidewalls of the cage. Thus, a larger space for the cage can be secured when a dimension of a horizontal cross-section of the elevator shaft is determined at a certain value. In other words, a dimension of the horizontal cross-section of the elevator shaft is reduced, when the dimension of the horizontal cross-section of the cage is determined at a certain value.

Further, since neither cage-side sheave nor hoist rope is present below the cage, a buffer disposed in the bottom of the elevator shaft can be disposed so as to be opposed to a center position of a bottom surface of the cage.

The traction sheave is disposed behind one of the right and left cage-side guide rails and is driven in rotation about a rotational axis extending in a forward and rearward direction. Thus, the traction sheave can be relatively freely disposed because the position of the traction sheave is not limited by the cage-side guide rails. As a result, the hoist rope can be passed round such that a part of the hoist rope extending between the right and left cage-side sheaves overlaps the center of gravity of the cage.

In the elevator system having no machineroom according to the present invention, the cage-side guide rails may be extended to a top of the elevator shaft.

Since the traction sheave is disposed behind one of the cage-side guide rails, and the driving apparatus is disposed behind the traction sheave, the pair of right and left cage-side guide rails can be extended to the top of the elevator shaft so that the cage can be raised fully to the uppermost position in the elevator shaft.

In the elevator system having no machineroom according to the present invention, the hoist rope may be composed of a plurality of ropes each having a diameter of from 4 to 6 mm.

Since each diameter of the ropes of the hoist rope is in a range of from 4 to 6 mm, each outer diameter of the traction sheave, the cage-side sheaves, and the counterweight-side sheave can be restrained to a range of from 200 to 250 mm.

Thus, the traction sheave and the pair of right and left cage-side sheaves can be relatively freely disposed in the elevator shaft, and the hoist rope can be more easily passed round such that a part of the hoist rope extending between the pair of right and left cage-side sheaves overlap the center of gravity of the cage, when viewed vertically from above.

In the elevator system having no machineroom according to the present invention, a rotational axis of the traction sheave and rotational axes of the cage-side sheaves may be extended each other at an angle of from 0 to 45 degrees when viewed vertically from above.

The angle between the rotational axis of the traction sheave and those of the cage-side sheaves is more preferably in a range of from 0 to 30 degrees, and most preferably, in a range of from 0 to 15 degrees.

That is, in the above elevator system having no machineroom, a torsion angle of the part of the hoist rope extending between the traction sheave and one of the cage-side sheaves can be reduced.

Thus, when the cage is raised to the uppermost position so that a vertical space between the traction sheave and the cage-side sheaves is decreased, an inclination angle of the hoist rope with respect to rope grooves of the traction sheave and the cage-side sheaves can be maintained to be small.

As a result, even when the hoist rope is composed of a plurality of ropes, generations of noises and vibrations caused by a contact between the rope composed of twisted lines and the rope grooves of the respective sheaves can be prevented.

In the elevator system having no machineroom according to the present invention, the pair of right and left cage-side sheaves may be disposed near the right and left sidewalls of the cage.

That is, in the above elevator system having no machineroom, one of the right and left cage-side sheaves can be directly below the traction sheave or near the same.

Since no diverting sheave is needed which is intervened between the traction sheave and the cage-side shaves, a vertical space between the top of the elevator shaft and the cage, that is, a top clearance can be reduced.

Since a large winding angle of the hoist rope with respect to the traction sheave can be taken, the hoist rope can be securely friction-engaged to the traction sheave.

In the elevator system having no machineroom according to the present invention, the pair of right and left cage-side sheaves may be disposed within a vertical projection of the cage when viewed vertically from above.

That is, in the above elevator system having no machineroom, a larger space for the cage can be secured when the sidewalls of the cage come close to the inner wall surface of the elevator shaft to have a certain dimension of a horizontal cross-section of the elevator shaft.

In other words, a dimension of the horizontal cross-section of the elevator shaft can be reduced when the dimension of the horizontal cross-section of the cage is determined at a certain value.

In the elevator system having no machineroom according to the present invention, the pair of right and left cage-side sheaves may be disposed symmetrically with respect to the center of gravity of the cage when viewed vertically from above.

The center of gravity of the cage means a position supposed in design when the cage has no passenger.

That is, in the above elevator system having no machineroom, since the pair of right and left cage-side sheaves are disposed symmetrically with respect to the center of gravity of the cage when viewed vertically from above, the constitution prevents a gravity acting on the cage and a force for raising the cage from largely offsetting with each other in a horizontal direction.

Thus, the cage can be stably suspended without inclination, and vertically moved in a smooth manner without vibration.

In the elevator system having -no machineroom according to the present invention, the driving apparatus may be disposed such that at least a part thereof overlaps the cage when viewed vertically from above.

That is, in the above elevator system having no machineroom, a space needed for driving the traction sheave in rotation can be secured, because at least a part of the driving apparatus is positioned above the cage.

Since one of the right and left sidewalls of the cage having the driving apparatus disposed thereon can be made close to the inner surface of the elevator shaft, a larger space for the cage can be secured when a dimension of the horizontal cross-section of the elevator shaft is determined at a certain value.

That is, a dimension of the horizontal cross-section of the elevator shaft can be reduced when the dimension of the horizontal cross-section of the cage is determined at a certain value.

In the elevator system having no machineroom according to the present invention, the traction sheave may be disposed such that at least a part thereof overlaps the cage when viewed vertically from above.

That is, in the above elevator system having no machineroom, not only a space needed for the traction sheave can be secured, but also the traction sheave can be disposed directly above one of the right and left cage-side sheaves or near the same.

Since no diverting sheave is needed which is intervened between the traction sheave and the cage-side shaves, a vertical space between the top of the elevator system and the cage, that is, a top clearance can be reduced.

Further, since a large winding angle of the hoist rope with respect to the traction sheave can be taken, the hoist rope can be securely friction-engaged to the traction sheave.

### BRIEF DESCRIPTION OF THE DRAWINGS

FIG. 1 is a perspective view showing an embodiment of an elevator system having no machineroom according to the present invention;

FIG. 2 is a perspective view showing a main part of FIG. 1 in enlargement;

FIG. 3 is a top view showing the elevator system having no machineroom shown in FIG. 1;

FIG. 4 is a front view schematically showing positions of a traction sheave and cage-side sheaves;

FIG. 5 is a front view schematically showing a conventional elevator system having no machineroom; and

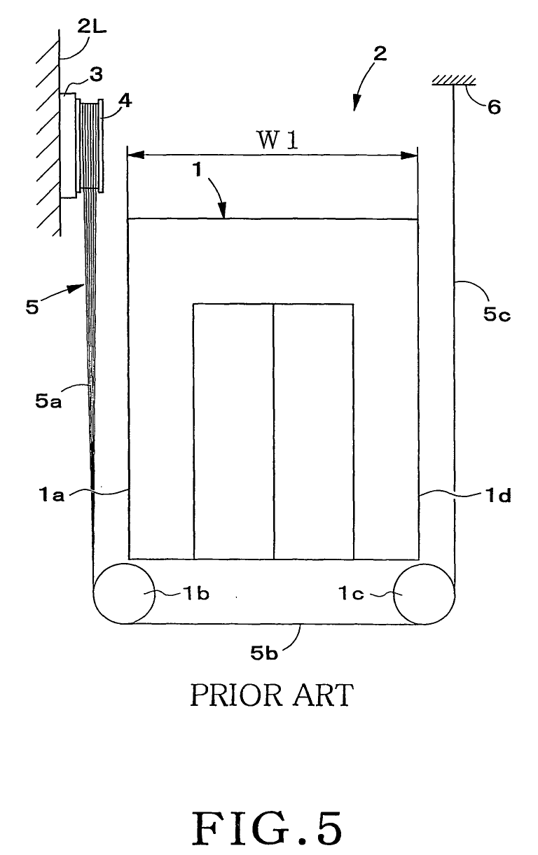

FIG. 6 is a top view of the elevator system having no machineroom shown in FIG. 5.

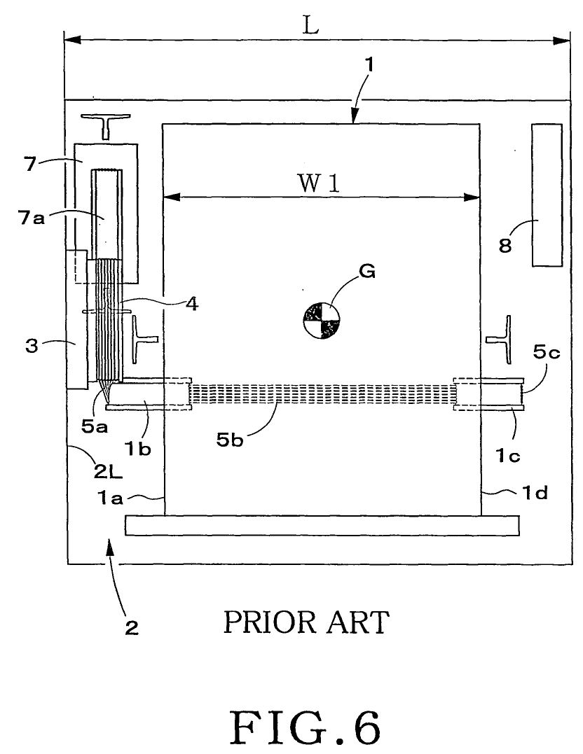

### DETAILED DESCRIPTION OF THE INVENTION

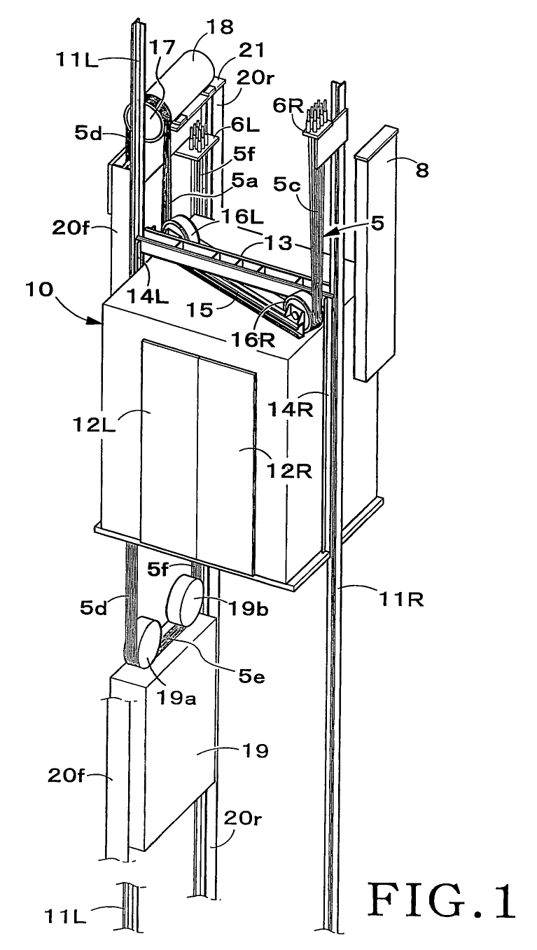

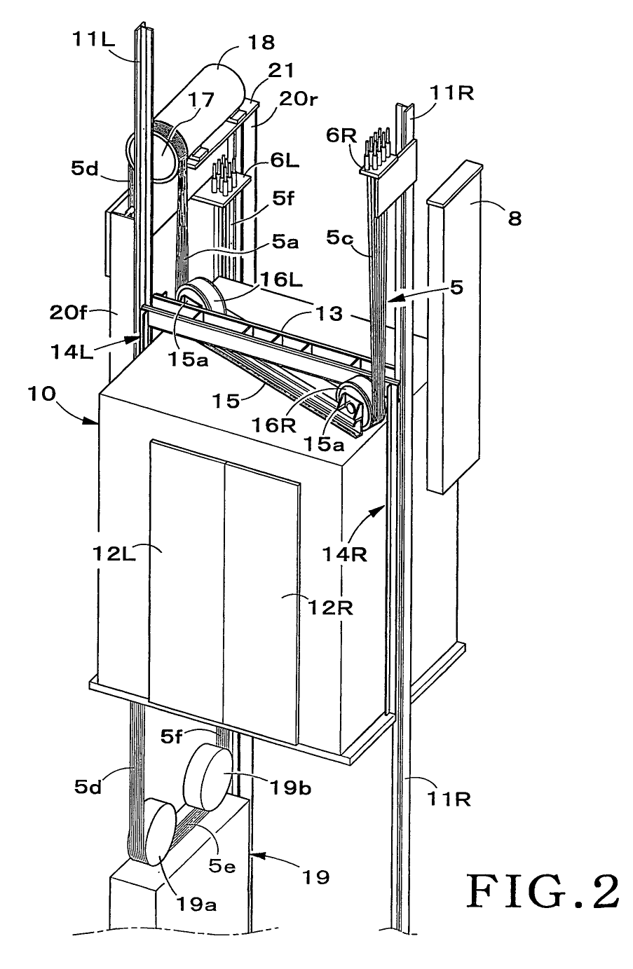

An elevator system having no machineroom according to the present invention is described below in detail with reference to FIGS. 1 to 4.

In the description, a direction in which a door of a cage is opened and closed is referred to as a right and left direction, a direction in which a passenger goes out from the cage is referred to as a forward direction, and a direction in which a passenger goes into the cage is referred to as a rearward direction.

The parts having the same structure and function have the same reference numbers, and their detailed description will be omitted.

An elevator system having no machineroom according to the present invention shown in FIGS. 1 to 4 includes a cage 10 which is guided by a pair of right and left cage-side guide rails 11L and 11R to vertically move in an elevator shaft 2 in a building.

A pair of right and left doors 12L and 12R disposed on a front surface of the cage 10 are opened and closed in a right and left direction.

A cage frame supporting the cage 10 includes an upper beam 13 horizontally extending in a right and left direction above the cage 10, and a pair of right and left vertical beams 14L and 14R which are respectively connected to right and left ends of the upper beam 13.

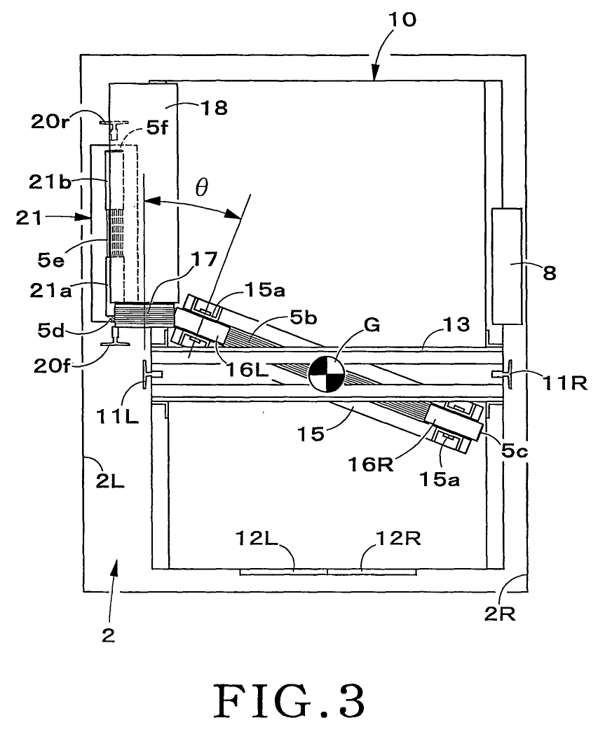

As shown in FIG. 3, a sheave support beam 15 is disposed in a vertical gap between the cage 10 and the upper sheave 13. The sheave support beam 15 is inclined in a forward and rearward direction and a right and left direction in a horizontal plane to intersect the upper beam 13 when viewed vertically from above. The sheave support beam 15 is upwardly apart from an upper surface of the cage 10.

The sheave support beam 15 is connected to the upper beam 13 such that an upper surface of the longitudinal center part of the former is in tight contact with a lower surface of the longitudinal center part of the latter. Thus, a force acting on the pair of right and left cage-side sheave 16L and 16R for elevating the cage 10 can be transmitted to the cage 10 from the sheave support beam 15 through the upper beam 13 and the pair of right and left vertical beams 14L and 14R.

Brackets 15a for rotatably supporting the pair of right and left cage-side sheaves 16L and 16R are respectively disposed on upper surfaces of end parts of the sheave support beam 15.

Since the sheave support beam 15 can be disposed on a level lower than rotational axes of the pair of right and left cage-side sheaves 16L and 16R, the upper beam 13 of the cage frame can be disposed close to the upper surface of the cage 10.

Thus, when the cage 10 is elevated to an uppermost position, a vertical space between a top wall of the elevator shaft and an uppermost part of the cage 10, that is, a top clearance can be reduced.

As shown in FIG. 3, a traction sheave 17 which rotates about a rotational axis horizontally extending in a forward and rearward direction is disposed behind the left cage-side guide rail 11L.

A driving apparatus 18 for driving the traction sheave 17 in rotation is disposed behind the traction sheave 17. The driving apparatus 18 is concentric with the traction sheave 17.

A pair of front and rear counterweight-side guide rails 19f and 19r for guiding a counterweight 19 vertically moving along a left wall surface 2L of the elevator shaft 2 are disposed below the driving apparatus 18.

The driving apparatus 18 is fixedly mounted on a support base 20 extended between upper ends of the pair of front and rear counterweight guide rails 19f and 19r.

Since the left cage-side guide rail 11L can be extended to the top of the elevator shaft 2 without interfering with the traction sheave 17, the driving apparatus 18, and the support base 21, the cage 10 is capable of being elevated to the top of the elevator shaft 2.

The traction sheave 17 has a hoist rope 5 wound thereabout which is composed of eight ropes parallel to one another each having an outer diameter of 5 mm, for example.

A first part of the hoist rope 5 includes a part 5a extending downward from the traction sheave 17 to the left cage-side sheave 16L, a part 5b extending horizontally between the pair of right and left cage-side sheaves 16L and 16R which suspend the cage 10, and a part 5c extending upward from the right cage-side sheave 16R to the right hitch 6R to be secured thereto. The cage 10 is suspended in a two-to-one roping arrangement.

A second part of the hoist rope 5 includes a part 5d hanging down from the traction sheave 17 to the counterweight 19 disposed below the traction sheave 17, a part 5e extending horizontally between the pair of front and rear counterweight-side sheaves 19a and 19b which suspend the counterweight 19, and a part 5f passed around the rear counterweight-side sheave 19b, extending upward to the left hitch 6L supported by the support base 21, and secured to the hitch 6L. The counterweight 19 is suspended in a two-to-one roping arrangement.

As shown in FIG. 3, the pair of right and left cage-side sheaves 16L and 16R are disposed symmetrically with respect to the center of gravity G of the cage 10, when viewed from above.

That is, the pair of right and left cage-side sheaves 16L and 16R are disposed such that the part 5b of the hoist rope 5 extending horizontally between the pair of right and left cage-side sheaves 16L and 16R passes an upper part of the center of gravity G of the cage 10, when viewed vertically from above.

The pair of right and left cage-side guide rails 11L and 11R are disposed symmetrically in a right and left direction with respect to the center of gravity G of the cage 10.

Since this constitution prevents a gravity acting on the cage and a force for raising the cage from largely offsetting with each other in a horizontal direction, the cage can be stably suspended without inclination and vertically moved in a smooth manner without vibration.

In an embodiment of the present invention, the hoist rope 5 is composed of narrow ropes each having an outer diameter of 5 mm, for example. Thus, each outer diameter of the pair of right and left cage-side sheaves 16L and 16R can be as small as 200 to 250 mm, which can prevent an interference of the pair of right and left cage-side sheaves 16L and 16R with the upper beam 13. As shown in FIG. 3, an angle between the upper beam 13 and the sheave support beam 15 can be made smaller, when viewed vertically from above.

Accordingly, an angle 0 between a rotational axis of the traction sheave 17 and those of the pair of right and left cage-side sheaves 16L and 16R can be made smaller, when viewed vertically from above.

This constitution can restrain a torsion angle of the part 5a of the hoist rope 5 extending between the traction sheave 17 and the left cage-side sheave 16L as small as possible. Thus, when the cage is raised to the uppermost position so that a vertical space between the traction sheave 17 and the left cage-side sheave 16L is decreased, an angular displacement of a direction where rope grooves, which are concavely disposed in outer peripheries of the traction sheave 17 and the left cage-side sheave 16L, are extended, from a direction where each rope is extended can be restrained to be small.

To describe more in detail, the rope is not always extended vertically downward from the rope groove of the traction sheave 17 to the left cage-side sheave 16L, but extended downward slightly inclined in a forward and rearward direction as well as a right and left direction according to a position of the left cage-side sheave 16L. A friction is thus generated between wall surfaces of the rope grooves of the traction sheave 17 and each of the ropes. However, in an elevator system having no machineroom according to the present invention, an angular displacement of a direction where the rope grooves are extended from a direction where each rope is extended can be restrained to be small.

As a result, generations of noises and vibrations caused by a contact between the respective ropes composed of twisted lines and the rope grooves of the respective sheaves can be prevented. In addition, an endurance of the hoist rope 5 can be improved.

In disposing the pair of right and left cage-side sheaves 16L and 16R and the pair of right and left cage-side rails 11L and 11R symmetrically with respect to the center of gravity of the cage 10, locations of the driving apparatus, the traction sheave, the cage-side sheaves, the guide rails, and so on are relatively freely determined in the elevator shaft 2, as compared to the conventional elevator system in which a traction sheave and cage-side sheaves are disposed such that rotational axes thereof are parallel to one another by using a flat and flexible rope or belt.

That is, since the traction sheave 17 and the pair of cage-side sheaves 16L and 16R are disposed as described above, dispositions of other components can be relatively freely determined according to the forms of the cross-sections of the elevator shaft 2 and the cage 10.

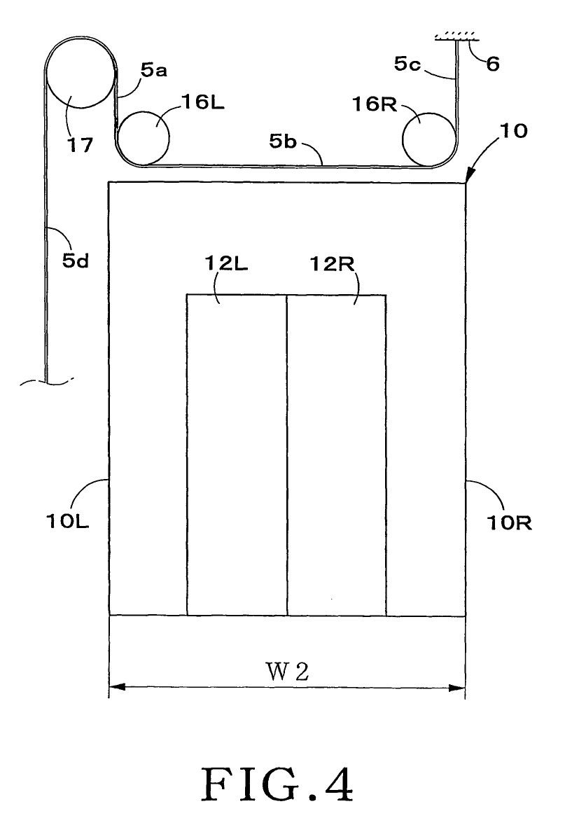

As shown-in FIG. 4, the pair of right and left cage-side sheaves 16L and 16R are disposed above the cage 10 near the right and left sidewalls 10L and 10R of the cage 10.

Thus, it is not necessary to provide an operation space in the bottom of the elevator shaft for maintaining the pair of right and left cage-side sheaves 16L and 16R, so that a height of the pit in the bottom of the elevator shaft can be reduced.

Further, since neither cage-side sheave nor hoist rope is present below the cage 10, a buffer disposed in the bottom of the elevator shaft can be disposed so as to be opposed to a center position of a bottom surface of the cage 10.

Maintenances for the pair of right and left cage-side sheaves 16L and 16R, the traction sheave 17, the driving apparatus 18, and the controller 8 disposed on the top of the elevator shaft for controlling an operation of the driving apparatus 18 can be carried out at the same time on the upper part of the cage 10. Thus, an operator needs not to go up to the uppermost floor and down to the lowermost floor in the building, and a maintenance operation of the elevator system having no machineroom can be effectively carried out.

Since the hoist rope 5 is not extended along the right and left sidewalls 10L and 10R of the cage 10, a dimension of the cage 10 in a right and left direction can be increased to a dimension W2 such that the left sidewall 10L of the cage 10 is located below the traction sheave 17.

Therefore, a larger space for the cage 10 can be secured when a dimension of the horizontal cross-section of the elevator shaft is determined at a certain value.

In other words, a dimension of the horizontal cross-section of the elevator shaft can be reduced, when the dimension of the horizontal cross-section of the cage 10 is determined at a certain value.

Since the left cage-side sheave 16L is positioned directly under the traction sheave 17, a winding angle of the hoist rope 5 with respect to the traction sheave 17 can be taken as large as 180 degrees. Thus, the hoist rope 5 can be steadily friction-engaged to the traction sheave 17.

One embodiment of the elevator system having no machineroom according to the present invention has been described above in detail. However, the present invention is not limited thereto and various modifications and changes can be made.

For example, in the above embodiment, although the traction sheave 17 and the driving apparatus 18 are disposed along the left sidewall 2L of the elevator shaft 2, it is possible to dispose them along the right sidewall 2R of the elevator shaft 2.

In the above embodiment, parts of the traction sheave 17 and the driving apparatus 18 overlap the cage 10, when viewed vertically from above. However, the traction sheave 17 and the driving apparatus 18 can be disposed such that they are positioned in a space between the left sidewall 2L of the elevator shaft 2 and the left sidewall 10L of the cage 10.

As apparent from the above description, the present invention provides an improved elevator system having no machineroom in which a height of a pit in a bottom of an elevator shaft can be reduced, a maintenance operation can be carried out at once on an upper part of the cage, a dimension of the cross-section of the elevator shaft in a right and left direction can be reduced with respect to a width of the cage, and a hoist rope can be passed round such that a part of the hoist rope 5 overlaps the center of gravity of the cage when viewed vertically from above.

1. An elevator system having no machineroom comprising:
a cage guided by a pair of right and left cage-side guide rails to vertically move in an elevator shaft;
a traction sheave disposed behind and near one of the pair of right and left cage-side guide rails, and driven in rotation about a rotational axis extending in a forward and rearward direction;
a driving apparatus, disposed behind the traction sheave, for driving the traction sheave in rotation;
a counterweight guided by a pair of front and rear counterweight-side guide rails to vertically move in the elevator shaft below the driving apparatus;
a pair of right and left cage-side sheaves which suspend the cage and is capable of rotating about a rotational axis extending parallel to a rotational axis of the traction sheave, or extending at a direction angle close to that of the rotational axis of the traction sheave; and
a hoist rope composed of a plurality of ropes wound around the traction sheave, having a first part suspending the cage through the pair of right and left cage-side sheaves, and having a second part suspending a counterweight.

2. An elevator system having no machineroom according to claim 1, wherein
the cage-side guide rails are extended to a top of the elevator shaft.

3. An elevator system having no machineroom according to claim 1, wherein the hoist rope is composed of a plurality of ropes each having a diameter of from 4 to 6 mm.

4. An elevator system having no machineroom according to claim 1, wherein
a rotational axis of the traction sheave and rotational axes of the cage-side sheaves are extended each other at an angle of from 0 to 45 degrees when viewed vertically from above.

5. An elevator system having no machineroom according to claim 1, wherein
the pair of right and left cage-side sheaves are disposed near the right and left sidewalls of the cage.

6. An elevator system having no machineroom according to claim 1, wherein
the pair of right and left cage-side sheaves are disposed within a vertical projection of the cage when viewed vertically from above.

7. An elevator system having no machineroom according to claim 1, wherein
the pair of right and left cage-side sheaves are disposed symmetrically with respect to the center of gravity of the cage when viewed vertically from above.

8. An elevator system having no machineroom according to claim 1, wherein
the driving apparatus is disposed such that at least a part thereof overlaps the cage when viewed vertically from above.

9. An elevator system having no machineroom according to claim 1, wherein
the traction sheave is disposed such that at least a part thereof overlaps the cage when viewed vertically from above.
